(19) United States
(12) Patent Application Publication
(10) Pub. No.: US 2013/0242549 A1
(43) Pub. Date: Sep. 19, 2013

(54) TEST DEVICE FOR LED LIGHT BAR

(71) Applicant: CHIH-CHEN LAI, Tu-Cheng (TW)

(72) Inventor: CHIH-CHEN LAI, Tu-Cheng (TW)

(73) Assignee: HON HAI PRECISION INDUSTRY CO., LTD., Tu-Cheng (TW)

(21) Appl. No.: 13/526,545

(22) Filed: Jun. 19, 2012

(30) Foreign Application Priority Data
Mar. 16, 2012 (TW) 101109027

(51) Int. Cl. F21V 21/00

(52) U.S. Cl. 362/221

(57) ABSTRACT

A test device is used for testing performance of an LED light bar. The LED light bar includes a substrate and a plurality of LEDs arranged on the substrate. Each LED includes an anode and a cathode. The test device includes an elongated first plate, an elongated second plate and a circuit structure. A plurality of electrode pairs is arranged on a first surface of the first plate. Each electrode pair includes a first electrode and a second electrode. The circuit structure is arranged on the first plate. When the test device is used for testing performances of the LEDs of the LED light bar, the first electrode of each electrode pair is electrically connected to the anode of a corresponding LED, and the corresponding second electrode of each electrode pair is electrically connected to the cathode of the corresponding LED.

### BACKGROUND

1. Technical Field

The present disclosure relates to test devices and, more particularly, to a device for an light emitting diode (LED) light bar with high testing efficiency and accuracy.

2. Description of Related Art

LEDs have many advantages, such as high luminosity, low operational voltage, low power consumption, compatibility with integrated circuits, easy driving, long term reliability, and environmental friendliness have promoted their wide use as a lighting source.

An LED light bar has an elongated circuit board and a plurality of LEDs mounted on the circuit board along a line. The LED light bar is used to replace the conventional fluorescent tube. It needs to check locations of the LEDs on the circuit board, electrical connections between the LEDs and the circuit board and the performance each LED of the LED light bar before the LED light bar is shipped to the customer. A conventional test is to provide a power source with two first electrodes, and the two first electrodes are respectively electrically connected to two second electrodes of the LED to check the performance of the LED. The test needs to be repeatedly performed for each LED; accordingly the conventional test is time consuming and laborious, which results in a low testing efficiency. To check whether the LEDs are correctly mounted on the circuit board, a manual visual check is usually used. However, such a manual check is not accurate. Error often happens. Accordingly, the conventional check is not accurate.

Therefore, what is needed is a test device, which can overcome the above described shortcomings

### BRIEF DESCRIPTION OF THE DRAWINGS

FIG. 1 is a top view of a test device, in accordance with a first embodiment of the present disclosure.

FIG. 2 is a front view of an LED light bar to be tested.

FIG. 3 is a top view of the LED light bar to be tested of FIG. 2.

FIG. 4 shows the test device of FIG. 1 being used to check the LED light bar of FIG. 3.

FIG. 5 is a top view of a test device, in accordance with a second embodiment of the present disclosure.

### DETAILED DESCRIPTION

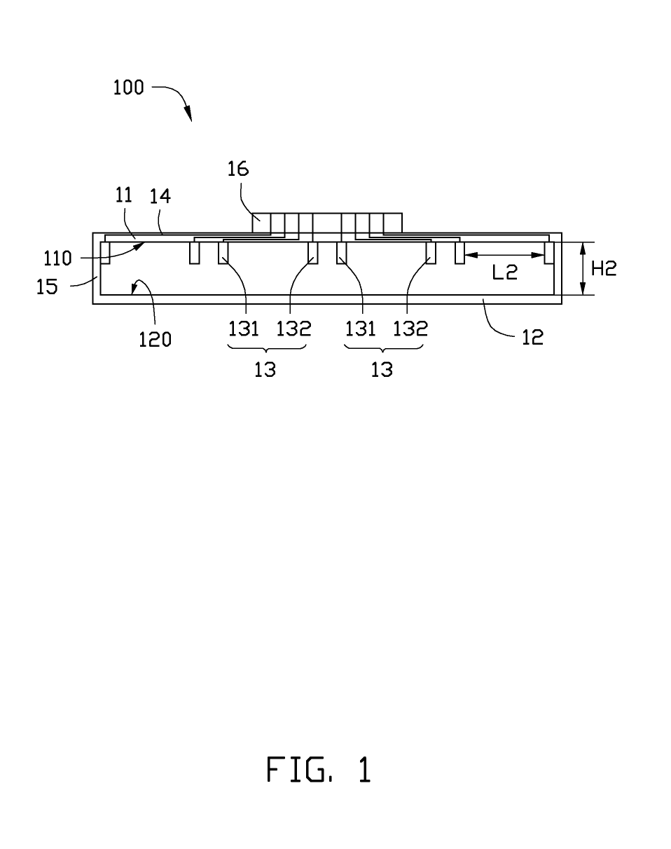

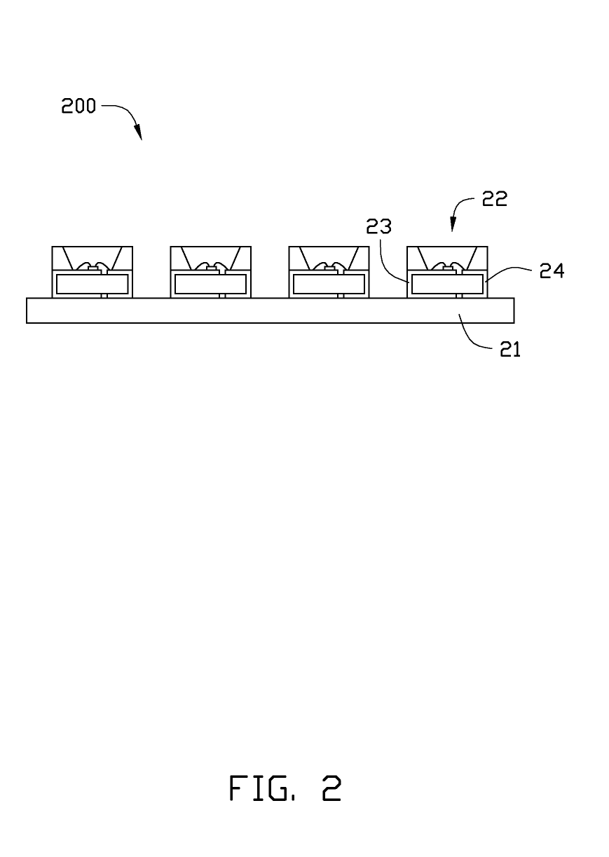

Referring to FIG. 1, a test device 100, in accordance with a first embodiment, is used for testing performances of LEDs of an LED light bar 200 of FIG. 2.

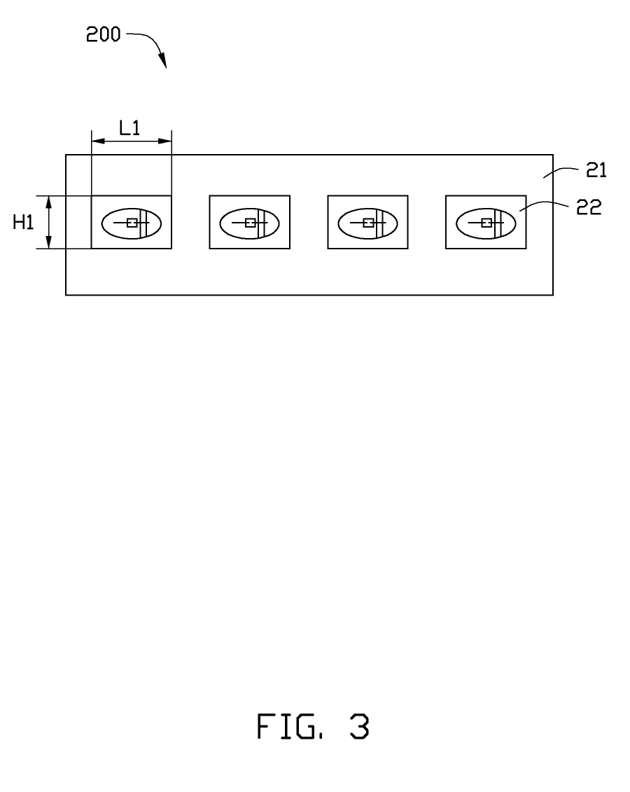

Referring to FIGS. 2 and 3, the LED light bar 200 includes a substrate 21, and a plurality of LEDs 22 evenly mounted on the substrate 21 along a lengthwise direction of the substrate 21. The substrate 21 is a circuit board, particularly a printed circuit board. Each LED 22 includes an anode 23 and a cathode 24. The anode 23 and the cathode 24 electrically connect to an LED chip (not labeled) of the LED 22 and mounted on a top face of the substrate 21, whereby the LED 22 is formed as a surface mounting type device. A distance between outer side surface of the anode 23 and outer side surface of the cathode 24 of each LED 22 is regarded as length L₁ of the LED 22. A width of each LED 22 is H₁. In the present embodiment, the length direction is perpendicular to the width direction. The LEDs 22 are mounted on the substrate 21 along a straight line.

Referring to FIG. 1 again, the test device 100 includes a first plate 11, a second plate 12 opposite to the first plate 11, plural electrode pairs 13, and a circuit structure 14.

The first plate 11 and the second plate 12 are elongated plates. The first plate 11 includes a first inner surface 110, the second plate 12 includes a second inner surface 120 opposite to the first inner surface 110 of the first plate 11. Two supporting plates 15 are arranged between the first plate 11 and the second plate 12. One of the supporting plates 15 connects to one end of the first plate 11 and one end of the second plate 12. The other supporting plate 15 connects to another end of the first plate 11 and another end of the second plate 12. In the present embodiment, the supporting plates 15 are integrally formed with the first plate 11 and the second plate 12 as a single piece. In other embodiments, the supporting plates 15, the first plate 11, and the second plate 12 can be separated formed from each other and then assembled together. The first plate 11 is cooperative with the second plate 12 for clamping the LEDs 22. In the present embodiment, a distance H₂ between the first plate 11 and the second plate 12 is substantially equal to the width H₁ of each LED 22.

The electrode pairs 13 are arranged on the first surface 110 of the first plate 11. In the present embodiment, the first plate 11 has four electrode pairs 13 formed thereon. Each electrode pair 13 includes a first electrode 131 and a second electrode 132. In the present embodiment, the shape and size of the first electrode 131 are substantially same as that of the second electrode 132. When testing the electrical property of the LEDs 22, the first electrode 131 is electrically connected to an anode 22 of the LED 22, and the second electrode 132 is electrically connected to the corresponding cathode 23 of the LED 22. In the present embodiment, a distance L₂ between the first electrode 131 and the corresponding second electrode 132 of each electrode pair 13 is substantially equal to the length L₁ of the LED 22. It can be understood that the number of the electrode pairs 13 can be changed according to the number of the LEDs 22 on the substrate 21.

The circuit structure 14 are arranged on the first plate 11 and electrically connected to the electrode pairs 13. The circuit structure 14 can be electrically connected to an exterior power source (not shown) for providing electric power to the LEDs 22. In the present embodiment, the circuit structure 14 extend to an outer edge of the first plate 11 to form a golden finger connector 16; the golden finger connector 16 can match with a golden finger interface (not shown) of the exterior power source.

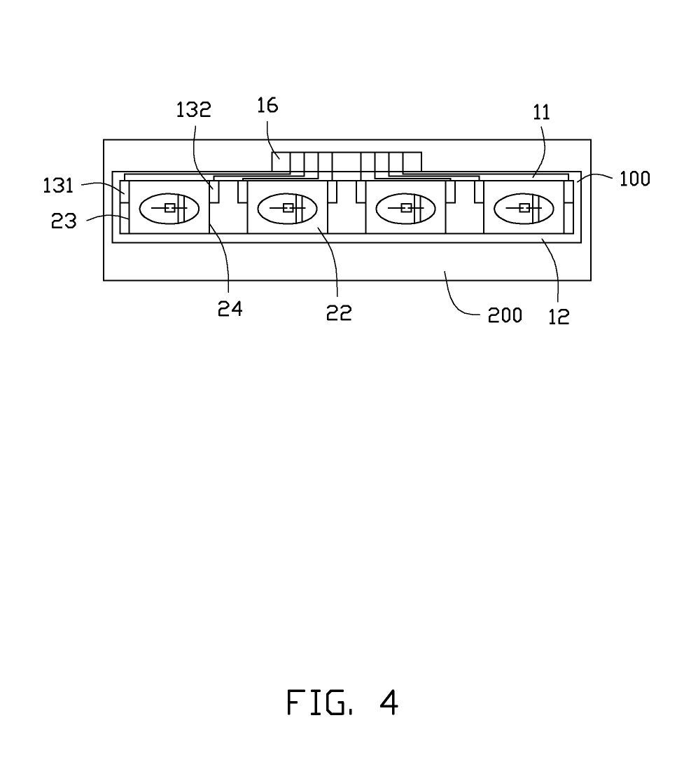

Referring to FIG. 4, when the test device 100 is used for testing performances of the LEDs 22 of the LED light bar 200, the test device 100 is pushed downwardly to the LED light bar 200 from a top thereof until the first plate 11 and the second plate 12 clamp the LEDs 22 therebetween; therefore, each of the first electrodes 131 is electrically connected to the anode 23 of each of the LEDs 22, and the corresponding second electrode 132 is electrically connected to the corresponding cathode 24 of each of the LEDs 22. The golden finger connector 16 is electrically connected to the exterior power source to provide electric power for the test device 100. If all of the LEDs 22 of the LED light bar 200 emit light, this represents that the performances of the LEDs 22 of the LED light bar 200 are alright. If one of the LEDs 22 of the LED light bar 200 fails to emit light, it represents that the LED 22 and thus the LED light bar 200 can not perform properly. A maintenance or replacement is required. If the test device 100 cannot be pushed downwardly onto the LED light bar 200 properly since one or more the LEDs 22 engaging bottom(s) of one or both of the first and second plates 11, 12 to block the pushdown of test device 200, which means that the LEDs 22 are not aligned with each other and arranged along a straight line; accordingly not all of the LEDs are mounted on their intended positions, whereby a re-soldering of the LEDs 22 of the LED light bar 200 which are shifted from their intended positions is required.

The test device 100 can test the LEDs 22 of the LED light bar 200 at the same time, whereby it can improve the test efficiency. Further the positional correctness of the LEDs 22 can be checked by the test device 100, not by a manual visual inspection; thus, the accuracy of the check of the LED light bar 200 is enhanced.

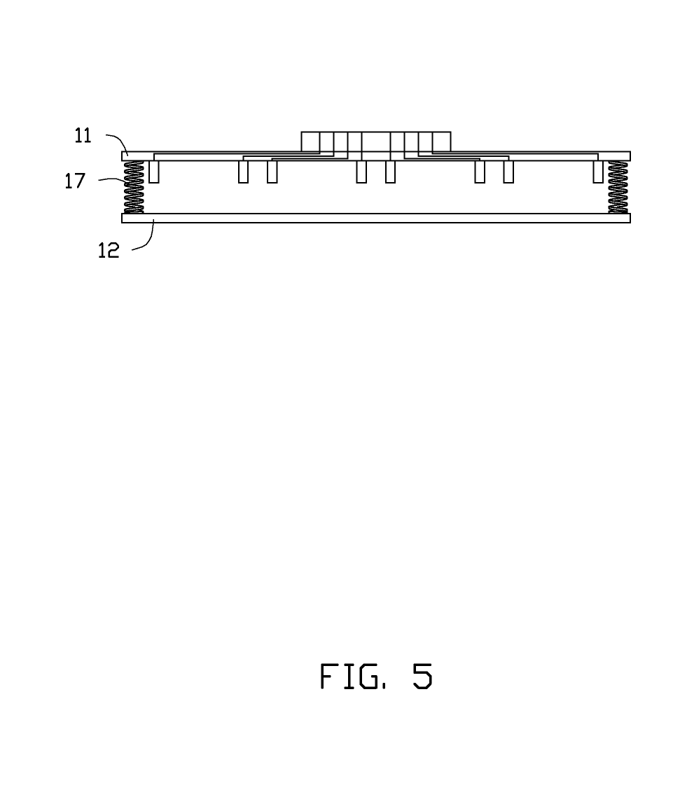

Referring to FIG. 5, a test device 200, in accordance with a second embodiment is shown. Differing from the test device 100 of the first embodiment, two elastic members 17 are arranged between and connected to two opposite ends of the first plate 11 and the second plate 12. In the present embodiment, the elastic members 17 can be selected from springs, elastic flakes and so on. In FIG. 5, the elastic members 17 are helical springs. Since the first plate 11 and the second plate 12 are connected via the elastic members 17, the distance between the first plate 11 and the second plate 12 can be adjusted, and the test device 200. In use, the test device 200 is mounted onto the LED light bar 200 with the second plate 12 engaging a common front side of the LEDs 22; then, the first plate 11 is pushed toward a common rear side of the LEDs 22 until the electrode pairs 13 engage with the anodes 23 and cathodes 24 of the LEDs 22 to see whether all of the LEDs 22 can emit light thereby the check the performances of the LEDs 22. On the other hand, when the second plate 12 is used to engage the common front side of the LEDs 22 and the front side of one of the LEDs 22 is spaced a gap from the second plate 12, it can be determined that the LED 22 is shifted from its intended position, whereby the LED light bar 200 needs a maintenance to re-solder the misaligned LED 22.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A test device for testing performance of an LED light bar, the LED light bar comprising a substrate and a plurality of LEDs arranged on the substrate along a line and mounted on the substrate by surface mounting technology, each LED comprising an anode and a cathode, the test device comprising:
an elongated first plate, the first plate having a first surface;
plural electrode pairs arranged on the first surface of the first plate, each electrode pair comprising a first electrode and a second electrode; and
a circuit structure arranged on the first plate, the circuit structure adapted for electrically connecting the electrode pairs to an exterior power source for providing electric power to the LEDs;
wherein when the test device is used for testing performances of the LEDs of the LED light bar, the test device is mounted on the LED light bar, the first electrode of each electrode pair is electrically connected to the anode of a corresponding LED, and the corresponding second electrode of each electrode pair is electrically connected to the cathode of the corresponding LED.

2. The test device of claim 1, wherein the LEDs are evenly mounted on the substrate along a lengthwise direction of the substrate, and the electrode pairs are evenly formed on the first plate.

3. The test device of claim 1, further comprising a second elongated second plate opposite to the first plate, the second plate being cooperative with the second plate for clamping the LEDs therebetween.

4. The test device of claim 3, further comprising at least one supporting plate arranged between the first plate and the second plate for connecting the first plate and the second plate, an alignment of the LEDs being decided by seeing whether the LEDs are able to be received between the first and second plates.

5. The test device of claim 4, wherein a distance between the first plate and the second plate is substantially equal to a width of each of the LEDs.

6. The test device of claim 3, further comprising at least one elastic member arranged between the first plate and the second plate for connecting the first plate and the second plate.

7. The test device of claim 6, wherein an alignment of the LEDs is decided by seeing whether the second plate is able to engage all of front sides of the LEDs.

8. The test device of claim 1, wherein a distance between the anode and the cathode of each LED is substantially equal to a distance between the first electrode and the second electrode of each electrode pair.

9. A test device for testing performance of an LED light bar, the LED light bar comprising a plurality of LEDs arranged along a line, the test device comprising:
an elongated first plate, the first plate having a first surface;
an elongated second plate cooperative with the first plate for clamping the LEDs of the LED light bar therebetween; and
plural electrode pairs arranged on the first surface of the first plate, each electrode pair comprising a first electrode and a second electrode, the electrode pairs being configured to connect an exterior power source for obtaining electric power;
wherein when the test device is used for testing performances of the LEDs of the LED light bar, the first electrode of each electrode pair is electrically connected to the anode of a corresponding LED, and the second electrode of each electrode pair is electrically connected to the cathode of the corresponding LED.

10. The test device of claim 9, wherein the LED light bar further comprises a substrate, the LEDs being evenly mounted on the substrate along a lengthwise direction of the substrate, and the electrode pairs are evenly formed on the first plate.

11. The test device of claim 9, further comprising at least one supporting plate arranged between the first plate and the second plate for connecting the first plate and the second plate, an alignment of the LEDs being decided by seeing whether the LEDs are able to be received between the first and second plates.

12. The test device of claim 11, wherein a distance between the first plate and the second plate is substantially equal to a width of each of the LEDs.

13. The test device of claim 9, further comprising at least one elastic member arranged between the first plate and the second plate for connecting the first plate and the second plate, an alignment of the LEDs is decided by seeing whether the second plate is able to engage all of front sides of the LEDs.

14. The test device of claim 9, wherein a distance between the anode and the cathode of each LED is substantially equal to a distance between the first electrode and the second electrode of each electrode pair.
